(19) United States
(12) Patent Application Publication
(10) Pub. No.: US 2001/0037890 A1
(43) Pub. Date: Nov. 8, 2001

(54) System of structures for open offices

(76) Inventor: Arturo Calvo Ospina, Bogota, DC (US)

Correspondence Address: Peter A. Sullivan, Hughes Hubbard & Reed LLP, One Battery Park Plaza, New York, NY, 10004-1482, US

(21) Appl. No.: 09/799,335

(22) Filed: Mar. 5, 2001

(30) Foreign Application Priority Data
Mar. 9, 2000 (CO) 2000-17013

(51) Int. Cl. H02G 3/04

(52) U.S. Cl. 174/48

(57) ABSTRACT

A system of structures for open offices which is versatile, aesthetic and provides easy access to work areas. In one embodiment, a spine of panels offers versatility in locating electrical and communication wires, with outlets located at any height according to each user's specific requirements, eliminating the need for additional supports. Another embodiment allows quick reconfiguration of space through the use of free position elements, permitting the user to modify the design of work areas using panels that allow adjustment between one panel and the next without installing additional elements. A leveling system ensures alignment of the panels.

### OBJECT OF THE INVENTION

The object of the Utility Model Patent Application herein is to provide a System of Open Office Structures consisting in the combination of several systems intended to obtain a disposition of open offices which have an easy access to them, with an aesthetic type and of good performance, constituting a support for different working styles according to the modem world, that increases the versatility of all the above mentioned characteristics.

### BACKGROUND OF THE INVENTION

At this moment, different systems intended to subdivide working spaces are known in the market, this are dismountable and portable, that make the Open Offices.

The Invention Patent Application herein was found at the Superintendence of Industry and Trade Documentary Fund which are filing their approval procedures and whose owner is STEEL CASE INC., a company with main offices in the United States of America, with the following characteristics:

Docket No. 95-62157 titled “Wall constructions intended to subdivide working spaces in a construction that comprises panels and connectors, including the covers optionally; connection systems for panels and methods”, these were submitted on Dec. 28, 1995, describing the construction of a wall that comprises:—a first panel that has lateral and vertical flanks;—an out of the module connector which includes hooks horizontally faced and spaced;—a second panel that has a marginal flank in order to be located adjacent in front of the first panel; additionally, it includes a panel connector located along the marginal flank.

Docket No. 97-73938 titled “Portable and Dismountable System Division”, presented on Dec. 18, 1997, which mentions and describes a dismountable frame construction comprising the following:—at least to vertical putlogs, each one of them with a upper end and a lower end and opposed faces over which there are at least two girder connection ports, positioned adjacent to the respective associated putlog upper and lower ends;—upper and lower girders which are horizontally extended between the putlogs;—first quick disconnection connectors positioned in the putlogs and adjacent to the connection ports;—second quick disconnection connectors positioned in the girders and adjacent to the connection ports located there in order to embed the first quick disconnection connectors aimed to interconnect rigidly but in a dismountable manner the putlogs and the girders, for a quick and complete assemble and disassemble of the dismountable frame. Electrical wires are found threaded through the panels, as it can be seen in FIG. 1.

Docket No. 98-26432 titled “Portable and dismountable division system”, submitted on May 12, 1998, in which the electrical system is found threaded through the lateral and vertical flanks, such as it may be seen in FIG. 2.

### PRECEDING ART DISADVANTAGES

Systems used for subdividing working spaces which are found in the state of the art, have the following inconvenients:

The monolithic frames, permit only to pass electrical wires through the plinth.

Electrical wires are found threaded through the structures that conform the system, making necessary to spoil them completely in case of any change, making difficult to carry out any required repair or change.

Electrical outlets to different heights, are difficult to install due to the wires threading position through structures.

In the traditional system, electrical outlets are connected directly to caps found in the structure's plinth.

Fixation system of panels to the structure, is made by means of pins that enter into a frame in a perpendicular form, leaving a free space between one panel and the other, requiring it to place a profile in the inferior part, with the aim to cover it.

### INVENTION'S ADVANTAGES

Application herein for an Open Offices Structures System Utility Model Patent, have following advantages in respect with it:

A great performance and esthetic open office is obtained because it uses, in one configuration alternative, a spine of panels as element of support, being at the same time, something like an “Intelligent Wall” that offers the possibility to administer electrical and communication wires, with outlets located at any height according to each user's specific necessities, eliminating the usage of additional supports and reducing in this manner office's inventory, saving also time and money significantly.

It makes easier a quick re-configuration through the use of free position elements, permitting to widen working areas, to change in an easy manner the design, and to create independent spaces or to integrate them.

The panels fixation system permits a perfect adjustment between a panel and the next one, not being necessary to install additional elements.

The designs and their different parts, fulfill international technical norms.

Availability of a screw driving chassis for electrical outlets, that does not make part of the structure, and that, if not required, same can be taken away without the need of spoiling the whole panel.

Product adapts itself to the user's needs, and not the user to the product.

### DESCRIPTION OF ATTACHED FIGURES

FIG. 1. Perspective view of the electrical cabling arrangement which are wired through the panels of state of the art. Attorney's Docket No. 97-73938.

FIG. 2. Perspective view of the electrical cabling arrangement which are wired through the panels of the state of the art. Attorney's Docket No. 98-26432.

FIG. 3. Side and perspective views of connector (1) of the invention.

FIG. 4. Side and perspective views of connector, change of height (3).

FIG. 5. Perspective view of the block of change of height (4).

FIG. 6. Side and perspective views of an edge, change of height (5).

FIGS. 7a, 7b, 7c, and 7d. Perspective sides in L shaped poles (11), T (12), X (13) and I (14).

FIG. 8. Front side of the double glass interchangeable panel

FIG. 9. Back and front views of the electrical harness (19).

FIG. 10. Front view of the electrical insulation system alongside the panel frames (16).

FIG. 11. Perspective view of the chassis for outlets (22).

FIG. 12. Disassembly view of panel frame (16).

FIG. 13. Attachment claps view (34) and (35) of panels.

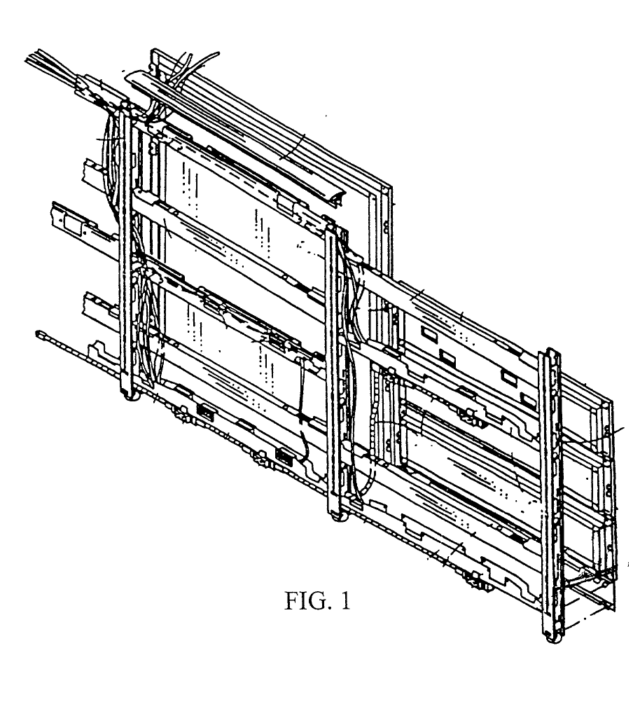

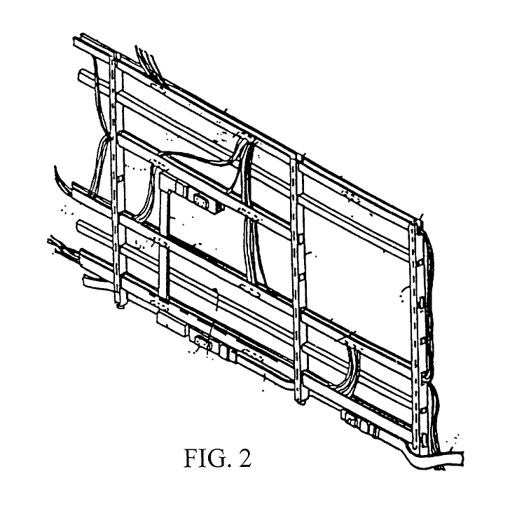

### DESCRIPTION OF INVENTION

This Open Office Structure System Utility Model patent application comprises the following items: (a) a connections system and levelling of structure, (b) a horizontal and vertical levelling overlaying cabling system, (c) a screwing outlet chassis, (d) an electrical insulation system located at its baseline, or any other height, (e) a structural system for different applications through a frame, and (f) a panels fixing system.

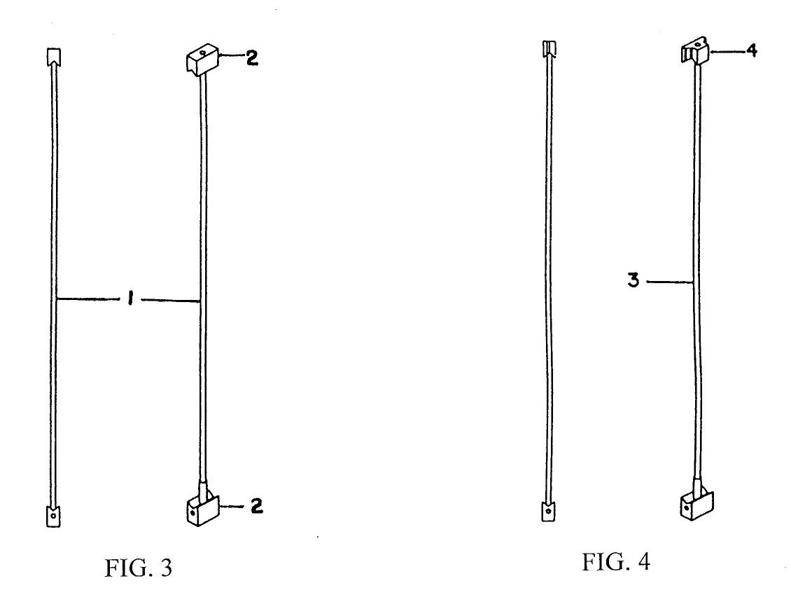

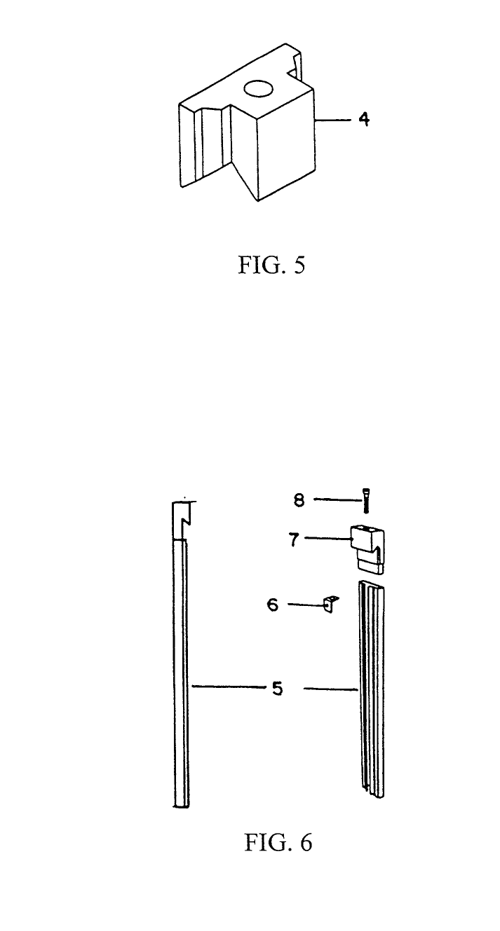

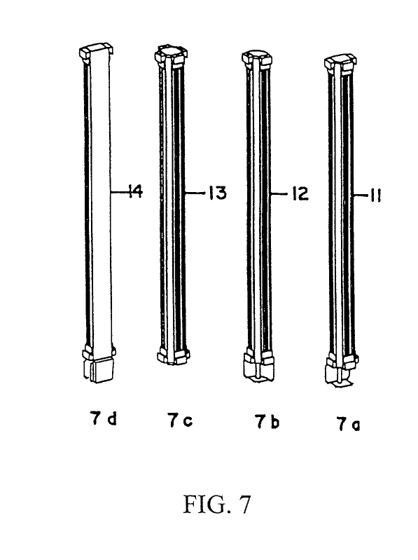

(1) The structures connection and simultaneous levelling system consists of the following: (a) a profile used as a connector (1) of a panel to another panel as seen in FIG. 3 herein. This profile is tubular shaped, and is provided with hardware attached to the endings thereof (2), while it also connects one panel to another one, providing a snug levelling and aligning thereto. Connector (1) features several heights, and it is directly to the panel zippers and it may feature different configurations, depending upon the number of panels to be attached thereto; (b) Connector, height change (3), panel-panel, tubular, connector which is seen in FIG. 4 making it possible to directly change the height of the set of panels, being it directly connected to the zippers of panels; (c) a height change block (4), in an irregular parallelepiped shape, with which height changes are accomplished with right at the set of panels, assuring the profiles levelling as seen in FIG. 4 and 5, permitting the perfect alignment of panels; (c) a border of height change (5) in an irregular parallelepiped shape, which is used to vertically and directly finishing the zipper exposed part thereof, as shown in FIG. 6. This item is composed of a bracketing wedge (6), upper block (7), screw (8) and the edge profile (9); the height change edge (5) is specified according to the difference of heights among the frames to be connected which can be as follows:—height change edge (1) board, height change edge (2) boards, height change edge (3) boards; (d) L shaped poles (11), T shaped (12) and X (13), which permit the joints of 2, 3, or 4 90 degree angle panels and pole 1 (14), the attachment of two panels in 180 degrees angle, which are shown in FIGS. 7a, 7b, 7c, and 7d, respectively. Additionally all poles permit the attachment of different height panels at the same pole, since each of the sides thereof is provided with holes for accommodating attaching fittings at any height. All poles are provided with a baseline section in coherence with the pole shape and with the panel baselines.

(2) Frames system whose tubular rectangular configuration provide the necessary support for installing interchangeable boards of different finishing therein, and also to hang several different office equipment both efficiently and safely. As said boards are installed upon the frame, they make the faces of panels. Said panels include the glass board, the tapestry board, the metal board, agglomerated board, electrical output boards, etc.

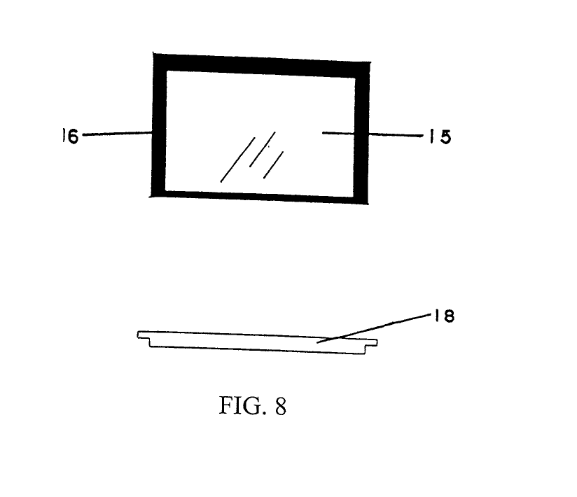

The interchangeable double glass board as seen in FIG. 8 includes the following: (a) tempered glass (15) with oven vitrified rectangular serigraphy, (b) a decorative plastic profile (18) which accomplish with the duty of framing the glass board internally within the metal frame (16); (c) clap attachment system, which are placed on the four (4) corners of the board, which enable the board to lead the board up to its normal position during the installation process, attaching the tempered glass (15) to the frame (16).

The windows arrangement can be placed anywhere on the structure.

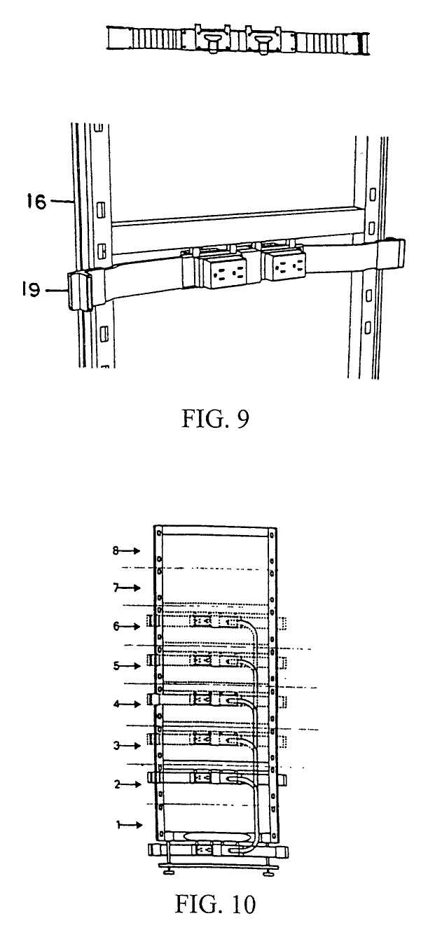

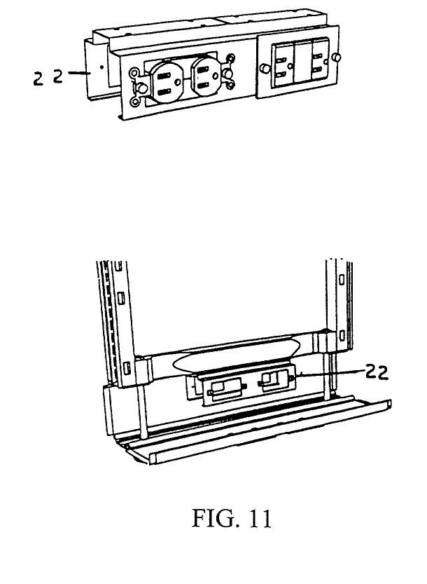

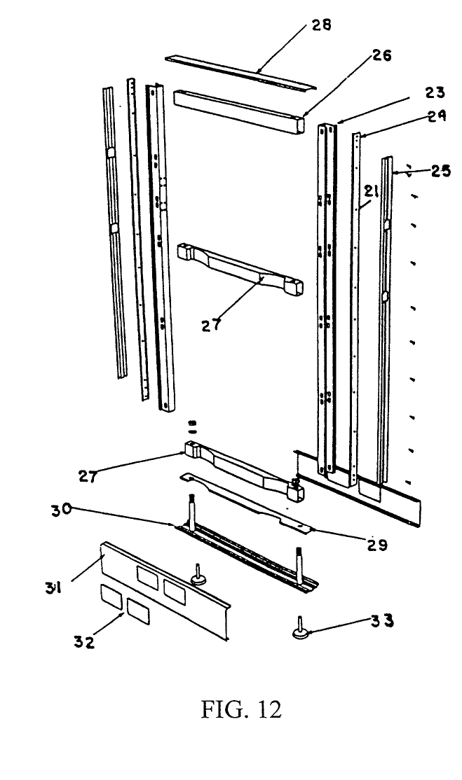

(3) Cabling laying system (horizontally or vertically overlaid). This system enables the installation or change of cabling without disassembling the entire structure. There are two cabling systems available, as follows: (a) modular system, and (b) local system. The cabling modular system consists of placing an electrical harness (19) on one of the frames of the panels. Said harness is the system main force and comprises a thin belt like device, with two couplings (10) to the ends to be joined to other harnesses, making it possible to place or not outlets of several specifications, in compliance with international standards as seen in FIG. 9, as the modular conduction and connection are both performed.

The harness can operate as a baseline or to any other height making an integrated part of the frames, thus making it possible to make the configuration of the work stations in a simple, safe and fast manner. When the harness is used to half height, the boards covering it on the two sides thereof should be made in tapestry or painting. Once the harness has been installed it does not remain sight exposed.

(b) Local cabling laying system which makes it possible to place frames without having to interlink them into the panel structure, being it feasible to place electrical outlets on the frames through a chassis for outlets (22), as seen in FIG. 12. The outlets chassis (22) is a frame functional device (16), which permits different kinds of electrical, telephone outlets and switches and the like being installed wether on baseline or to any height. It can also be withdrawn at any time without disassembling the entire panel as it is linked to the panel structural part through screws. Up to twelve outlets per panel can be available, six (6) on each side, being also possible to make combinations among the different types of sockets.

(4) The electrical insulation system at the baseline level or to any other height is attained by passing the electrical wires through the horizontal lower pipe endings (27) and the side cavities of the clamping sheet (29), making an electrical barrier providing a vertical insulation, as seen in FIGS. 10 and 12.

(5) Structural system for different applications, wherein the structure frame, according to FIG. 12, is made by: (a) a vertical profile (23), to which the boards making the faces of panels are attached; (b) a locking profile (24), which interacts with the vertical profile (23), providing support to the zipper (25); (c) a zipper (25), which supports the office equipment and accessories by means holes (21) featured at 1′ (25.4 mm) intervals, attached to the closure profile (24) through screws; (d) a horizontal upper pipe (26), making the upper closure, also permitting the fixation of the frames of growth, linked to vertical profiles (23) by continuous welding; (e) horizontal lower pipe (27), which permits the vertical cabling without threading or breaking the structure, making the frame lower closure and also permits to fix the electrical components at baseline level and middle height as well; it is linked to vertical profiles (23) through welding; (f) upper edge (28), decorative component of the frame which finishes in the panel upper face, snap on installed; (g) clamping sheet (29), a functional component of frame permitting the passage of electrical cables through the lower horizontal pipe (27) using its side cavities; (h) tray-baseline (30), a structural and functional frame component supporting the panel on the lower section thereof, also providing the internal spacing for the cabling conduit. Due to its geometry it permits that the baseline side faces are hinged so that the access to its internal section is provided; (i) conduit side (31), which is a functional and esthetic device to the panel, which forms the side faces of the baseline, which due to its geometry it is hinged to the tray of baseline in order to have access to the inner side thereof, (j) lid for socket (32), which is a functional and esthetic component of the baseline which enabled to be withdrawn when sockets are to be snapped on placed, (k) leveller (33), which is a frame functional device allowing to levelling the set of panels, assuming also the unevenness of the surface upon which it is supported, as the base thereof rotates by 30 degrees.

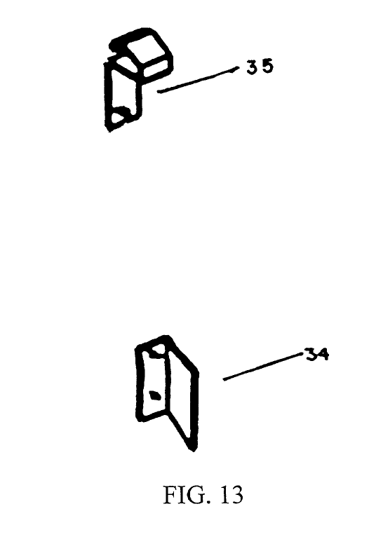

(6) A panels fixation system made up by two types of clamps, one of which is a positioner (34), as seen in FIG. 13, made by a sheet which has been bent on two perpendicular sides, one of which sides is in parallel to the panel to which the clamp is attached to by means of screws while the perpendicular side enters into a vertical rectangle of the frame placing the panel or board when guided to its final position, over the lower panel without leaving any span between one and the other, it also bears the weight of the board and the components thereof, without requiring any additional items, and another retaining clamp (35) formed by a five folding sheet, as shown in FIG. 13, wherein one of the sides is in parallel to the board or panel to which the clamp is attached to with screws, one of which is perpendicular which is also bent by 90 degrees, then it is bent to 30 degrees, and lastly it is bent until remaining perpendicular to the board, pressed into the frame by fixing the board, adjusting it when opening.

### List of Reference Signs Used

1. Connector

2. Hardware

3. Connector, height change

4. Block, height change

5. Edge, height change

6. Supporting wedge

7. Upper block

8. Screw

9. Edge profile

10. Electrical harness lock (19)

11. L shaped poles

12. T shaped pole

13. X shaped pole

14. I shaped pole

15. Tempered glass

16. Metal frame

17.

18. G lass packing profile

19. Electrical harness

20. Electrical jumper

21. Holes

22. Chassis for sockets

23. Vertical profile

24. Locking profile

25. Zipper

26. Upper horizontal pipe

27. Lower horizontal pipe

28. Upper edge

29. Baseline attachment

30. Baseline tray

31. Side conductor

32. Lid for socket

33. Leveller

34. Board or panel positioning clamp

35. Board or panel retaining clamp

1. An open offices structures system FEATURING the following components: (a) a structure connection and levelling system; (b) a system of laying of vertically or horizontally overlapped cables; (c) a screwed socket chassis; (d) an electrical insulation system at baseline leveller at any other height; (e) a structural system for different applications through a frame; and (f) a boards fixing system.

2. The connection and levelling system herein comprising a profile which is used as a connector of one panel to another one, featuring hardware in its ends, also connecting one panel to another levelling and aligning them accurately. The connector features different heights and it is directly connected to the zippers of panels having different configurations depending upon the number of panels which are intended to be attached together as stated in claim 1, FEATURING also: (a) a panel to panel, tubular height change connector, which connects the panels to the zipper; (b) a height change block, connecting the panels to the zipper at different height; (c) a height change edge, which is installed to finishing vertically the zipper exposed section; which comprises a supporting wedge, upper block, screw and the edge profile; the height change edge is specified according to the height difference between the frames to be connected, likely consisting of a height change edge of 1 board, height change edge of 2 boards, height change edge of 3 boards.

3. Overlapping cabling laying system at horizontal and/or vertical level as described in claim 1, which can be accomplished with by using a cabling modular system which consists of a system wherein the frame of panels is provided with an electrical harness, which is a principal part of the system. This section consists of a thing belt like device, with couplings to its ends to be connected to other harnesses being it possible to install or not sockets of different kinds and specifications, in compliance with international standards; and (b) a local cabling system FEATURING a local system of application of cables wherein cables are placed oer the frames without routing them through the panel structure, with the possiblity of installing electrical outlets over the frames through a chassis for outlets.

4. A local cabling system as described in claim 3, FEATURING a chassis for sockets, which is a functional component of the frame, to which several types of electrical and telephone outlets are installed, including switches, etc, at the baseline level or at any height. This part can be withdrawn as it is screwed to the panel structural section.

5. A structural system of claim 1, FEATURING an electrical insulation system consisting of passing the electrical wires through the endings of the lower horizontal pipe and the side cavities of the attaching sheet, thus forming an electrical barrier producing the cabling vertical insulation.

6. A structural system of claim 1, FEATURING a structural system for different applications through the frame of the coupling system comprising the following: (a) a vertical profile, to which the boards making the faces of the panels are attached to; (b) a locking profile which interacts with the vertical profile for supporting the zipper; (c) a zipper to which the equipment and accessories are attached to through the holes placed at 4 mm intervals; (d) an upper horizontal pipe, which forms the upper locking and to which the growing frames are attached to; (e) the lower horizontal pipe, which makes a lower locking of the frame, and to which the baseline and middle height electrical components are attached to; (f) an upper edge, which is a decoration component of the frame finishing in the panel upper face; (g) baseline attachment, which is a functional component of the frame for securing the baseline when it is in closed position; (h) baseline tray, which is a structural and functional component of the frame, supporting the lower section panel, through which internal spacing the cabling is passed through. Due to its geometry, it permits that the side faces of the baseline can be hinged to access its inner part; (i) side conductor, a functional and esthetic component of the panel, which forms the lateral faces of baseline, which due to its geometry it is hinged over the baseline tray to gain access to its inner part; (j) a lid for the socket, a functional and esthetic component of the baseline, which is removed whenever the sockets are to be installed; (k) leveller, a functional component of frame which levels the panels arrangement and takes the irregularities of the surface on which it is supported as the base thereof rotates by 30 degrees.

7. A structural system of claim 1, FEATURING a panels fixation system composed by two types of clamps, one positioner consisting of a sheet bent into two perpendicular sides wherein one side remains in parallel to the panel to which the clamp is fixed by means of screws and the perpendicular side, making a vertical rectangle of the frame positioning the panel or board while guided to its final position, over the lower panel, and another retaining clamp made by a five folding sheet, one side thereof in parallel to the board to which the clamp is screwed to, one in perpendicular which in turn is bent by 90 degrees and then by 30 degrees and lastly it is bent until remaining in perpendicular to the board, pressed into the framed by fixing the board and adjusting it when opening.
